(19) United States
(12) Patent Application Publication
(10) Pub. No.: US 2007/0174100 A1
(43) Pub. Date: Jul. 26, 2007

(54) Method and apparatus for synchronizing a scheduler with a financial reporting system

(76) Inventor: Daniel G. Roy, Raymond, NH (US)

Correspondence Address: Patent Dept. BAE SYSTEMS, PO Box 868, NHQ1-719, Nashua, NH, 03061-0868, US

(21) Appl. No.: 11/340,779

(22) Filed: Jan. 26, 2006

(51) Int. Cl. G05B 19/418

(52) U.S. Cl. 705/8

(57) ABSTRACT

In order to maintain the integrity of data between a scheduler and a financial management tool, current states of the two systems are compared and line items that do not agree are flagged, followed by an electronic recursive update of one of the systems based on an evaluation of the reason for the lack of correspondence. In one embodiment, a line-by-line comparison between the data in the two systems is made and any anomalies are flagged. The flagged anomalies are then presented to individuals who decide whether or not the anomaly is significant. If the anomaly is significant, then steps are taken, in one embodiment in the scheduler, to accommodate the difference between the two data sets.

### STATEMENT OF GOVERNMENT INTEREST

The invention was made with United States Government support under Contract No. M4422. The United States Government has certain rights in this invention.

### FIELD OF THE INVENTION

This invention relates to the project management and more particularly to the synchronization between a scheduling system and a financial management system that identifies, corrects and synchronizes data between the planning system data and the financial management system data.

### BACKGROUND OF THE INVENTION

In order to bid and execute government development and production contracts, companies must have an approved Earned Value Management System, EVMS. The purpose for having an earned value management system is to establish a process whereby work packets are identified and costs estimated into manageable, logical units of work content, with performance and accomplishment criteria gauged against these work descriptions that constitute exit criteria. These measured units of work, i.e., a work package, WP, are then evaluated or calculated by the financial management application within the earned value management system translated so one may evaluate whether a program is ahead, behind or on target for schedule and for cost.

Typically, companies have many choices in the selection of scheduling tools. Programs use a scheduling tool as the front end for an earned value management system because they are designed to capture the sequential order of the work that is to be accomplished. The scheduling tool thus captures the work flow. Typically, a scheduling tool is designed to hold resource or labor allocations in the form of a bidcode for each of the work packets that define the Work Package. A bidcode is a resource category, having a unique annual rate that is used to cost the corresponding work package.

Periodically, a program manager will obtain the status of the schedule from the scheduling tool, capturing such information as Actual Starts and Actual Finishes for any of the work packages in the schedule, the re-scheduling of future work due to changes in priorities or availability of resources to perform the work or as part of a Detailing Event, which is breaking down a Planning Work Package into smaller Work Packages, each discretely loaded with its own resources requirements so they may be measured by the earned value management system. A Planning Work Package or PWP is defined as a long duration and large resource estimate required for a future work scope. The value obtained in using a scheduling tool as the front end to an earned value management system is its ease of use, its visual capacity to display information in an easily understandable manner and its ability to be easily maintained.

The other part of the earned value management system is the Financial Management Tool. This tool is designed to price out units of work or bidcodes, prepare forecasts and produce reports that aid in the analysis of performance, cost and schedule goals of a program. Such a financial management tool is embodied in the Welcom Cobra system. One of Welcom's features is its capability to accept data from other commercial scheduling programs through a common interface. To use this interface, it is important that the data generated by the scheduler, i.e., what is exported, be properly accepted or imported into the financial management tool and that all errors reported during the import by the financial management tool be followed up and corrected. Even in the absence of errors on import, it is still possible for errors to surface, as some of the fields imported into Cobra are coding fields. If these fields are imported erroneously, then potential reporting changes could occur. It is the coding fields which are used by Cobra to organize data for reports and analysis.

Typically for project management, a scheduling tool such as Microsoft Project 2000 is interfaced with the Welcom Cobra financial management system. Note that both Microsoft Project and Welcom's Cobra are commercial products that can be used not only to support government earned value management system programs but also to be used by commercial entities, for instance general contractors and architects. These commercial users use Microsoft Project and Cobra for project cost management.

In order to create a schedule, the scheduling tool accepts user input in defining tasks descriptions, durations, resource assignments or allocations, predecessor dependencies to prior tasks and successors or receivers of the products produced by the work performed. The scheduler has an internal calendar so it may calculate start and end dates for these tasks based on precedence calculations. The resource allocations are typically captured by identifying a bidcode and an associated quantity of units of that bidcode estimated as required to perform the work. Daily use of the scheduler in support of a program involves creating reports which may contain a visual representation of the next reporting period, may contain a subset of the schedule which defines only those tasks required to complete a goal or milestone, called a filtered schedule, or may be a data collection report, dispersed throughout the organization to capture to what point in the development cycle the program is completed.

One of the requirements of an earned value management system is to capture the entire budget for the program, regardless of its duration. Once the program baseline is established, changes to the baseline must be reconciled to this original amount, unless new sources of outside funding are obtained or if allocations are made from the undistributed budget, UB, accounts or the management reserve, MR, accounts. The undistributed budget account is controlled and managed by the prime contractor or the government and is intended to hold budgets for future needs of the prime contractor or government agency until those needs are better defined. The management reserves are budgets are held by a program office as a reserve against future risks to a program. Thus, the scheduling tool must contain the entire allocated budget in terms of resource units, costed out by the financial management system.

A schedule is comprised of different types of work allocations. Since work that is planned to be performed in the near term is typically better defined than work further out in a program, two types of “Work Packets” have been defined. For near term work, the term “Work Package” is used. A Work Package is defined as having a defined work scope, defined entrance and exit criteria, a duration which meets the requirements of the Program Measurement Technique, PMT, applied and containing adequate funding in terms of a resource allocation estimate to complete the work.

There are many different types of Program Management Techniques, but all are broken down in two classes. The Level of Effort, LOE, PMT is reserved for use by the management structure of a program. It should not exceed 20% of the total value of an allocated budget. The second PMT type involves discrete measures. One can have tasks measured for a single fiscal month of performance, two fiscal months of performance and extended periods of performance greater than two fiscal periods. All of these share a common characteristic for having at least one measurement point for each fiscal month of a Work Package's duration.

There are other unique PMT classifications that are used to only measure material and other direct costs. Those work packets further out in a program are typically not as well understood and so may be planned at a higher level, meaning their durations may be much longer. These work packets are called “Planning Packages” and only need to respect fiscal year boundaries for durations to aid in reconciling and managing fiscal budget requirements with customers.

The challenge is to be able to manage the project over its life in spite of the inevitable number of changes, both in terms of re-allocation of resources, updates to the mission, and other program requirements.

The schedule development phase is accomplished first. In general, an organization is developed to design, plan and execute a program. These areas may include software, hardware, logistics, and repair. One would assign a cost account manager, CAM, for each of these responsibilities, with the cost account manager negotiating with the Program Office for its allocation of the total program budget based on his Basis of Estimate, an estimate to complete the contract-defined requirements by his planned staff. In this way, the cost account manager (CAM) defines and becomes responsible for those budgets allocated to his work scope. This responsibility entails identifying appropriately trained staff to perform the work, managing work flow, customer communications and meetings, meeting contractually defined deliveries of products to an agreed upon schedule and maintaining contract-defined quality levels. Thus, it is the cost account manager for each of the segments of the project who has the cost and schedule responsibility to manage the budgets and schedules.

Once having developed an initial schedule, it is important to be able to output the data from the schedule to a financial tool. One such financial tool is the aforementioned Welcom Cobra tool. Cobra accepts scheduler information through its user defined import interface. This interface accepts task descriptions, durations, dates and resource bidcode assignments, among other things. Cobra then calculates resource bidcode costs by applying a rate table against the bidcode. The rate table is a table containing fiscal cost rates for each bidcode. Normally, cost for future year's rates are increased over the current rates. Rate tables are designed to capture all overhead costs allocated to a program as a percentage of a particular program's contribution to demands for overhead services. Cobra further groups these costs by fiscal periods, which may be weekly, monthly, quarterly, or annually. Cobra further groups these costs by cost account manager and by cost account. The cost account is used to hold all budget, performance and actual costs for a specific narrow workscope in a program. Many companies also have “standard” cost account structures, which they tailor to individual programs. These standard cost account structures facilitate the development of metrics derived from past performance, which may then be used as predictors for future program estimating. The cost account matrix, typically called the Responsibility Assignment Matrix, requires that each and every cost account be owned by a single cost account manager. It is this degree of organization of cost, schedule and performance responsibilities into individual cost account manager centers for measurement that form the basis for an effective earned value management system.

While it is possible to attach a cost to a resource from the scheduler point of view, normally this is not done but rather is done in a separate financial application that is employed to do all of the costing. Reasons for this are many. The rate table typically covers multiple years for many individual bidcodes. Having to maintain two sets of rate tables for a program is another potential source of error. In addition, fiscal boundaries and calendars used by differing commercial products behave differently in how they perform calculations on their data. Finally, limitations in internal calculation capabilities between differing commercial products also contribute to creating calculation differences. All of these factors contribute to a low probability of being able to maintain an accurate budget baseline in both the scheduler and the financial management tool for extended periods of time.

Thus, in essence, the scheduler provides the mechanism for visualizing the architecture of the project and working with it in a user-friendly manner, whereas another piece of software is typically used to capture the financial measurement of the program. Note that the two systems are only perfectly synchronized on the original day of transfer from scheduler to financial management tool, because at that time the entire budget baseline is exported by the scheduler and imported by the financial management tool and costed. At this point in time the data in the scheduler and the data in the financial tool are identical. Even during the initial pass of information from the scheduler to Cobra, adjustments must be made to exactly balance budget allocations by the cost account manager such as to balance to the allocated baseline funding issued by the program office. These final adjustments must be flowed back into the scheduler as changes to ensure synchronization from the start.

Up until now, reconciliation has been a tedious manual exercise using numerous reports from the financial management tool to match up against data contained in the scheduler. Of course, the financial management tool does not calculate dates for the performance of a particular Work Package but merely accepts those dates on import from the scheduler. Thus, resource edits made in the financial management tool to balance to the allocation now have to be communicated back to the scheduling tool for them to maintain synchronization.

There are multiple types of events that drive change within the scheduler. These events can be grouped under categories of Approved Contract Baseline Changes, i.e., changes requested by the customer with new budgets allocated to complete the workscope; Detailing Events where a large existing Planning Work Package, PWP, is broken down into smaller, manageable Work Packages using PMT guidelines; rescheduling of work due to resource limitations or changes in priorities in which planned performance must be changed; or the statusing process, that is the process of updating individual tasks with performance starts or completion dates; or projections on future start or completion dates. All of these changes must be documented and traced through the earned value management system to ensure (1) they are entered into the scheduler correctly and (2) they are accepted by the financial management tool in identical fashion. All baseline changes have a requirement in that the net change must be $0, meaning that all budgets have been reconciled with the change and that there are no carry-overs. This is consistent with cost accounting standards used by accountants in defining acceptable accounting systems. If budgets do not balance, then the program Office must approve an allocation from management reserve to allow the performance measurement baseline to balance.

While one would think that this is a straightforward process, the change process within the scheduler and more specifically within the Microsoft Project software is composed of multiple steps, the failure of any one of which will cause invalid data to be transferred to the financial management tool. Note that in addition to creating new records and identifying the old records that are to be deleted, when one creates new records one can either change resources or change durations of the particular work package elements that are in the scheduler. In Microsoft Project, this is an eight- or nine-step process. Lack of attention in any of these steps can impact the integrity of the information accepted by the scheduler.

To document this change process, the following is provided by example. Budget changes within the scheduler may be a resource change or a task duration change. Microsoft Project has an internal process for these changes that a user must be aware of. This internal process identifies three values used to manage changes involving duration and resource changes. The formula used is Rate X Duration=Units. Microsoft Project allows the user to define one of these as frozen; the third value will vary and the second value is variable. So, in this example, to modify a duration, the user must set the “Maintain Resource Units” flag, keeping the resource assignment constant through the change. The rate is then allowed to vary as the duration is changed. However, when changing a Resource Unit assignment to a task, the user must set the “Maintain Task Duration” flag, keeping the task duration as fixed. The result is resource rate varying as the resource units are changed. The nine steps to incorporate a changes follows:
1. Select the task to change.
2. Set the Correct Flag for the type of change desired.
3. Click the task to initialize the record.
4. Change either the Task Duration or Resource units value
5. Again click the task line to incorporate and recalculate the change
6. Restore the Flag field to Fixed Work to maintain the resource assignment during status updates.
7. Save the baseline to establish new baseline dates and/or resource assignments for the task
8. save all changes by performing a file save.

Note that this eight-step process to effectuate a program change in the program is exceedingly error-prone.

Moreover, in the past, it was not well known that differences exist between what was specified by the scheduler and what was then resident in the financial management tool. Note, the above findings are the result of extensive research in identifying differences between data contained in the scheduler versus what is contained in the financial management tool. It has been documented that significant differences in unmaintained program files may exceed 10% error rates. Even on maintained programs, error rates exceed what would normally be considered acceptable by the financial community.

In summary, it is a common misconception that users of this data expect the data to be the same in both systems. The core issue is data integrity or having the expectation that a report from one tool will be in agreement with data contained in a report produced by the other tool.

Lastly, Microsoft Project has a dialogue box that is used to save changes to a file. On that dialogue box is a choice between saving new baselines for the entire program or only for selected activities. If the user makes an unintended choice and saves the new baseline for the entire program, then the errors due to changed data in the unintended tasks are non-recoverable except through the aforementioned manual method of comparing reports and performing individual updates as they are discovered.

There is therefore a necessity to provide a process control tool to be able to do a rapid comparison between the two systems, identify the differences, and develop a mechanism for evaluating and effecting changes either manually or in an automated fashion.

In job situations where differing individuals split the work of incorporating changes in the scheduler, good cooperation and communication are key to help keep the systems synchronized.

The above problem of synchronization has to take into account that the financial tool has an interface to its databases. Cobra is Oracle-based, meaning that Cobra does not hold the data itself but accesses the data from a central repository. To access this data, Cobra uses SQL, Structured Query Language, to retrieve and save its data. SQL is also available to users of Cobra through an interface it provides. This SQL interface can be used to extract programmatic data organized in a user specified manner with little programming expertise required. Once extracted, this data may be saved in Excel for later analysis or use.

In its early development, the first attempt to synchronize records was conducted in Excel. Data from the scheduling tool was pasted onto one sheet and data from Cobra using SQL was pasted onto another worksheet. A third worksheet was then used to perform successive lookups to detect differences between the two sets of data. This process was successful in only identifying differences, not in providing help in evaluation nor in implementing changes back into the earned value management system tools.

Since most users operate under the incorrect assumption that Microsoft Project and Cobra contain the same data, even if un-maintained, it is not surprising to see the reactions of users when they discover just how different the two tools might be in practice.

Drivers to the difference are not limited to data-input errors in the scheduler or un-resolved or invalid import errors into Cobra, but can be traced to the basic methods of calculation used by the two commercial tools. Microsoft Project contains an internal calendar, defining holidays and non-work days or weekends into work shifts. Microsoft Project may have multiple shifts with different vacation calendars embodied in multiple calendars active within a single project at any one time. These calendars affect how a task is calculated or how a resource spread is calculated, as resources can also have unique holiday and non-work periods assigned to them. Inconsistencies between the calendars are not generally recognized and Microsoft Project calendars are applied as selected by the user, who may not be aware of the above inconsistencies. The only assurance is that Microsoft project will apply the most restrictive condition when it calculates durations or resource spreads.

Moreover, durations in Microsoft Project are maintained internally to the accuracy of a minute. Thus an 8-hour workday duration is actually carried internally by Microsoft Project as 4800 minutes, 10×8 hours×60 minutes/hour. The “10” multiplier is used to increase precision. Resource Assignments are stored as minutes×1000. An assignment of 2 hours would be stored as 2 hours×60 minutes/hour×1000, or 120,000. Storing floating point numbers as integers drastically improves calculation times required by Microsoft Project. However, using calculation standards creates rounding issues, as base 60 numbers do not correlate well to base 10 numbers. Thus users need to be aware that some decimal values cannot be input into the scheduler due to these inconsistencies.

As will be appreciated, when evaluating calendars and calculations in Cobra, it was quickly discovered that Cobra has its own eccentricities. Cobra calendars are based on a 7-day workweek with no consideration for non-work periods like weekends. The only exception to the workweek is the defined holiday schedule. Occasionally, even holidays which occur over a weekend are not considered non-work periods. Moreover, it is not apparent that Cobra uses integer math for calculations. It is believed in Cobra that all values are held as floating point numbers and are then converted to an appropriate value at report time in Cobra. Thus, when extracting values from the Cobra database, the values obtained are floating point with a precision of 13 decimal digits.

Given the disparity in methods of calculation between the two tools, all that Cobra can do is accept data as provided by the scheduler and integrate it into its calendar. Thus, a 4-day work task which includes a non-work weekend in the scheduler is translated into a 6-day task in Cobra, because weekends are not considered non-work in Cobra.

In the worst case, the rounding error could be off by 1/100^{th} of a unit for resource assignments, whatever the unit represents, whether it is an hour of work or a dollar of material.

To highlight these impacts, programs are typically broken down into several hundred cost accounts, with each Cost Account containing several Planning Packages and multiple Work Packages. Even assuming a 10% error rate on resource assignments, one can see the potential cumulative effects of these calculation differences, which can mean significant errors errors of millions of dollars in large programs that must be made up out of pocket.

Rounding errors are in general taken out of the Management Reserve account held by the program office. Note that when there is a change in a program, the objective is to balance within a dollar. As a result, the program office absorbs all of the cumulative rounding errors through the life of a typical program, with the cumulative errors a direct draw against program profit.

### SUMMARY OF INVENTION

Rather than establishing manual processes for ascertaining the correctness of data or integrity of data between the scheduler and the financial management tool, and rather than requiring off-line processes that are exceptionally error-prone and time-consuming, in the subject invention the system compares the current states of the two tools and allows an electronic recursive update of one of the systems based on an evaluation as to the severity of any difference between the two data sets. For the present purposes, by recursive is meant going back, in one embodiment, to the financial management tool, to reconcile the two data sets to make them correspond. In order to perform the recursive update, there is a line-by-line comparison between the data in the two tools and anomalies are flagged. In one embodiment the flagged anomalies are then presented to individuals who decide whether or not the anomaly is significant. Alternatively, this can be done automatically. If the anomaly is significant, then steps are taken in the scheduler to accommodate the difference between the data sets in the two tools.

By automatically identifying all the differences between the current states of the two tools, the system provides the ability to generate data that is coupled back to the scheduler on a real-time basis to alter the schedule. Thus, what could be an all-day effort for a manual check, now takes five minutes or less in one embodiment.

In one embodiment, the scheduler file is read directly by the subject system. Data from the financial management tool is retrieved by utilizing the SQL interface to produce extracts of data that are saved into the Excel format. The subject system reads this extract directly from the Excel file and automatically updates the scheduler file electronically, once the errors have been evaluated and correct information is ready to be recursively input to the scheduler.

More particularly, the subject system generates a table of all of the fields that are being compared and displays the fields by record number, identifying through the use of flags whether they are the same or different. If a flag occurs for any field or any combination of fields associated with a record, then an operator can select the anomaly as an exception record and identify the difference between the two records. This is an automatic compare process, with the power of the subject system resulting from the ability to feed the differences back to the scheduler for restoring the integrity of the database so that the scheduler database is the same as the financial management tool database.

Note, there is an evaluation system within the subject system whereby all of the exception record data may be saved to Excel for later evaluation and consideration for updating to the scheduler. Sometimes there are errors in the financial management tool and sometimes there are errors in the scheduler. The display of the differences gives project managers a second chance to re-evaluate the project and make the correct decision as to what data in which tool needs to change.

Note that in the past most program managers proceeded under the false premise that the information from the scheduler was correct and where there were differences they were not significant. However, this is rarely the fact and the last day of the program is when one ascertains the amount by which profits must be offset by the cumulative errors.

By way of further background, all earned value management systems are validated against standards defined in Appendix B of the “Earned Value Management System Evaluation Guide.” This evaluation guide for use by the government in evaluating an implementation of EVMS on a program and uses a series of criteria in its evaluation. These criteria are listed below:
Criterion 1 Define the authorized work elements of the program
Criterion 2 Define the program organization structure
Criterion 3 Provide for the integration of the planning, scheduling, budgeting, work authorization and cost accumulation process with each other
Criterion 5 Provide for integration of the program work breakdown structure (WBS) in a manner that allows schedule performance measurement by elements of either or both, if needed
Criterion 9 Establish budgets for authorized work
Criterion 10 To the extent practical, identify the authorized work in discrete work packages, establish budgets for this work in terms of dollars, hours or other measurable units
Criterion 22 At least on a monthly basis, generate cost performance reports, which must be reconcilable with the company accounting system

There are many other evaluation criteria defined but they all share a common requirement of maintaining data integrity so that the data may be reconciled to company accounting systems. To accomplish this requirement using commercial products utilizing differing calculation methodologies and calendars requires a high degree of maintenance and validation.

In addition to the possibility of losing accreditation, the government is very astute at being able to identify anomalies. Upon identification of an anomaly, the government officials often ask questions about the anomalies during the program. The subject system, in addition to making sure that the two databases are in synchronization, also is a contributing factor in eliminating many of the anomalies that could come to the attention of the government.

Moreover, the subject system provides a logging function in that everything that is transpiring on the part of the review and update process is logged. Thus the subject system identifies where the data is being retrieved from, the number of errors or differences found and presents it in summary form. It also identifies gross differences, identifying tasks which are present in one tool but not in the other.

While it is possible in the subject system to change the databases in the two systems, it is more practical to change the data in the scheduler to agree with the financial management tool as opposed to incorporating changes in the financial management tool. It is generally recognized that it is the financial management tool that meets earned value management system requirements and that the data it contains should be considered accurate unless evaluation determines a mistake has been made. Correction of the financial management tool, particularly retroactive changes, requires customer notification and sometimes, even approval by the customer to incorporate the change. It may be necessary to document the root cause creating the need for the correction. In some cases, root cause analysis for the need for the change may also be requested. Of course, cumulative statistics on this type of activity may affect a company's ability to bid on future government work if an earned value management system is not adequately maintained.

Note that the scheduling tool is merely a tool that one uses to facilitate data input and to facilitate transfer of data. The scheduler itself is not concerned with maintaining data integrity. However, within an earned value management system involving the subject system, personnel have the ability and responsibility to evaluate every input they receive from planning as embodied in the scheduler to ensure that a change does not include a retroactive or invalid change.

Note that individuals inputting the schedule do not inadvertently want to make a change in the financial management tool and their responsibility is to ensure that the change that they are accepting is valid.

Moreover, when the program control individual notices that something is not right, there is a need to maintain an accurate record of changes to the input records so these same changes may be communicated and incorporated into the scheduler. This is a step often neglected, contributing to data disparities between the systems.

Note also that the interface between the two systems is not trivial. While some commercial products have a limited interface, such as Pert Chart Plus, which directly interfaces to the scheduler, its primary function is to create an enlarged view of the schedule so that it can be printed on a 40-inch-wide plotter. Thus, while Pert Chart Plus does provide an output from the scheduler, it is limited to retrieving data from only the task segment of the Microsoft Project database. It does not have a Microsoft Project Update mechanism, as it is only a display interface for Microsoft Project.

In contrast, the subject system can effect change not only to tasks data, but resource assignments as well. The subject system also retrieves calendar, resource table and other data from Microsoft Project to enable it to use Microsoft Project file preferences in performing recursive updates back into the scheduler. For example, the subject invention retrieves the list of holidays used by Microsoft Project and incorporates those holidays into the subject invention's internal calendar, used for updates to durations when schedule dates are changed.

Thus, with the subject system one is able to compare anything that is in the scheduler with anything that is in the financial management tool. As a result, in the subject system one is comparing the current states of two different systems and allowing an electronic recursive update of one of the systems based on the results of an evaluation of the comparison. The subject system identifies all of the differences between the two data sets and is able to input data back to the scheduler on a real-time basis to alter the project parameters, on a field-by-field and/or record-by-record basis.

When the analysis is done on the flagged differences, the program manager knows exactly what differences remain and their significance. Note that the subject system prevents errors that would re-baseline the entire project or result in loss of important information. For instance, in the worst case where one has re-baselined the entire project in error, the subject invention completely restores programmatic information obtained from Cobra back into Microsoft Project, in effect restoring a catastrophic re-baseline of a Microsoft Project file.

In the past the only way an operator would know that wrong data entry had occurred would be to look at the data in the schedule and manually compare the data to what is reported in Cobra on a report.

More particularly, the subject system compares the line items in a project at one point in time with its counterpart in the financial management tool. Identification of differences allows an update of all of the differences back to the scheduler. This can be done on a field-by-field basis or one can be selective. Note that in the automatic compare process one employs an interrupt, which results in a human being looking at the anomaly to ascertain whether it is important or not. The individual can then select what the changed data needs to be and input it directly into the scheduler.

As will be appreciated, in the subject system the evaluation is done field by field and one can group all of the records that are different within the field together so that one can evaluate all records with a single field difference all at once. Then check boxes are presented in one embodiment for each of the records to present a program manager with the ability to select whether or not he wants to update that particular record field. Once the evaluation is made, a run command is generated that saves the selected record field information to the scheduler.

When one has completed all of the edits, one can re-run the subject system on the same scheduler file to see what the remaining differences are and to validate that requested changes have been incorporated. The data logging facility records every change to every record at the field level, showing the “from and to” conditions surrounding the change. On the occasion that there are some changes that are not accepted for a variety of reasons, the analysis is re-run so that all desired updates are in fact incorporated. Finally, manually updating Microsoft Project data, based on the differences stored in the Excel file of all exception records, can also be used.

It is very important that the subject system maintain these records of changes. Manual records are important for anything that is imported into the financial management tool. As a result, one can manually verify, if required, what the approved changes were and what the values of these changes were. Thus, a hard copy of the financial management tool input records is maintained.

Note also that all changes have to be authorized by the cost account manager, the program control individual and the individual program manager on the program if the change results in a cost exceeding a predetermined dollar value. It is to be understood that the program control individual has a fiduciary responsibility to maintain the accuracy of the system. It is also noted that it is the individual charged with maintaining the financial management tool who has a fiduciary responsibility to maintain the scheduler and reconcile it with the company account records. Thus, there may be legal ramifications to the financial community in the case of a mismatch between the scheduler and the financial management tool.

In summary, in order to maintain the integrity of data between a scheduler and a financial management tool, current states of the two systems are compared and line items that do not agree are flagged, followed by an electronic recursive update of one of the systems based on an evaluation of the reason for the lack of correspondence. In one embodiment, a line-by-line comparison between the data in the two systems is made and any anomalies are flagged. The flagged anomalies are then presented to individuals who decide whether or not the anomaly is significant. If the anomaly is significant, then steps are taken, in one embodiment in the scheduler, to accommodate the difference between the two data sets.

### BRIEF DESCRIPTION OF THE DRAWINGS

These and other features of the subject invention will be better understood in connection with the Detailed Description, in conjunction with the Drawings, of which:

FIG. 1 is a block diagram showing a system for reconciling differences in the data sets between a scheduler and a financial management tool in which a comparison is made between the data sets, with exception flags set and tables of all records presented to permit a selective update of the scheduler in a recursive loop process;

FIG. 2 is a diagrammatic representation of the interpretation through the life cycle of a predetermined change in a project, in which a baseline change request is inputted to the scheduler to generate project updates, followed by transmitting the project updates to the financial management tool;

FIG. 3 is a diagrammatic representation of an original plan, followed by a new plan based on change orders in the original plan, showing an increase in the equivalent man-days for the project;

FIG. 4 is a diagrammatic illustration of an example of typical detailing for a baseline change process;

FIG. 5 is a diagrammatic illustration of a window in the scheduling tool for effectuating a change in resource amount, as well as an associated saved baseline dialogue box; and,

FIG. 6 is a diagrammatic illustration of a window in the scheduling tool showing changing a duration amount as well as an associated saved baseline dialogue box.

### DETAILED DESCRIPTION

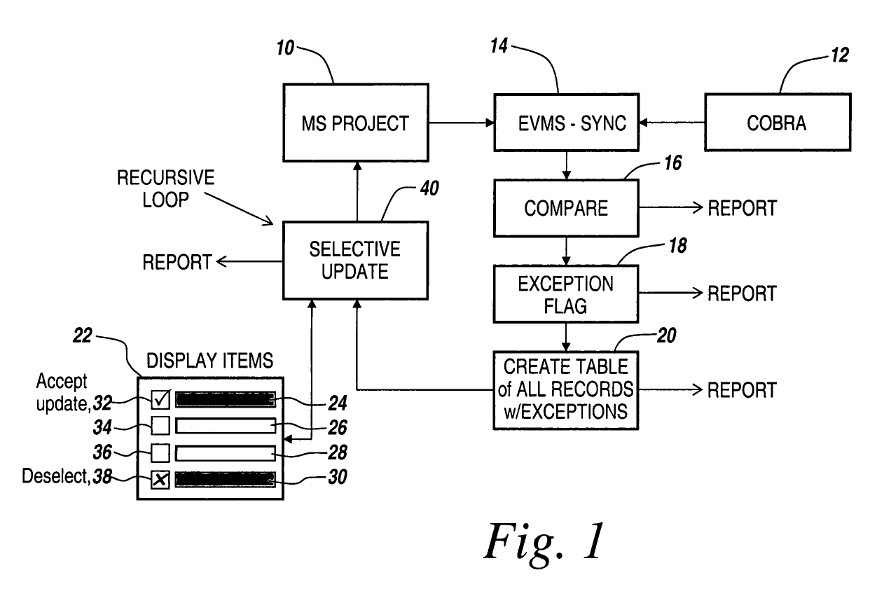

Referring now to FIG. 1, in the subject system two commercial products, namely a scheduling tool 10 and a financial management tool 12, in one embodiment including respectively Microsoft Project and Welcom's Cobra coupled to the subject synchronization system 14. This system is a synchronized earned value management system, EVMS-SYNC. Synchronization system 14 takes this information and performs an initial comparison of the selected text and date fields as illustrated at 16. Where any fields are different, the subject system flags the differences as shown at 18 and creates an exception table 20.

For all the records that have at least one difference within the record, as illustrated at 22 the subject system outputs an exception table to the operator using scheduler 10. As can be seen, each of the line items 24, 26, 28 and 30 has a corresponding checkbox 32, 34, 36 or 38 into which a check mark can be placed by the operator. This causes a selective update module 40 to input changes to the scheduler after they have been agreed upon between the planning and program control individuals as needing to be incorporated into the scheduler. Note that the data in lines 24 and 30 have been highlighted to flag the fact that the corresponding data is not consistent between the two tools. As can be seen, the change in the data in line 24 has been accepted, as illustrated by the checkmark, whereas the change in the data in line 30 has been de-selected by placing an X or not filling in box 38.

The update process back to the scheduler is referred to as being in a recursive loop, such that once a record has been identified and a field identified that needs to be updated, one simply presses a button and the update occurs electronically in the scheduler.

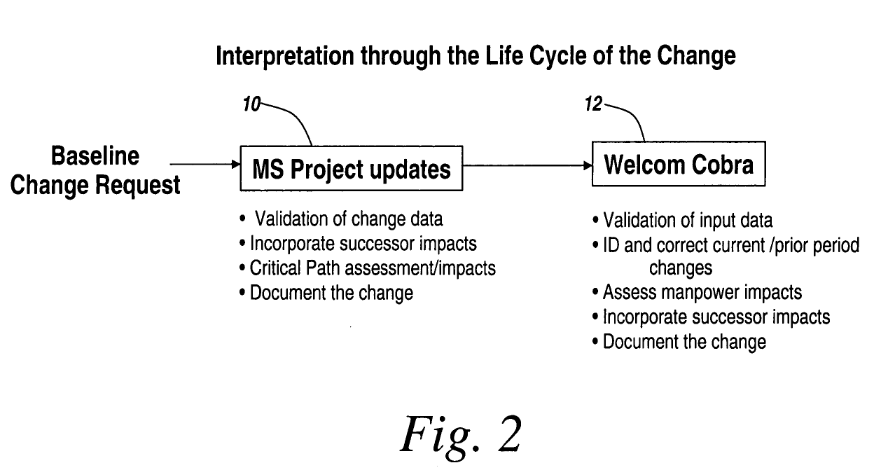

Referring now to FIG. 2, it is noted that as part of the synchronization process, each of the tools has to have a documentation trail of the change process. What initiates a change process is one of three or four different kinds of events. First, the type of event is input to the MS project update scheduler 10. For instance, one might have a detailing event where one is taking a long task with a large number of resources in it and breaks it down into smaller pieces. Within that environment there are some simple rules that one must maintain, such as respecting the start and end points of the large package when one is dealing out the small subsets.

One also needs to balance the project, meaning that the value of the resources donated by the Planning Work Package, PWP, equals the sum of all resources allocated to the new Work Packages.

All of this, of course, has to be part of the planning documentation package and when accomplished is transmitted to the financial management tool, here specifically Welcom Cobra 12. In so doing, one has to incorporate successor impacts. One has to evaluate critical path impacts and one has to document the changes.

In FIG. 2, as can be seen underneath the box referring to Microsoft Project 10, one needs a validation of change data; one needs to incorporate successor impacts; one needs to establish critical path assessment/impacts; and one needs to document the change.

Likewise on the financial management tool side, for financial management tool 12, one needs a validation of input data; one needs to identify and correct current or prior period changes; and one needs to assess manpower impacts, incorporate successor impacts and document the changes.

Note that in the update process, the program control individual must validate that the changes embodied in the scheduler export records were accepted exactly by Cobra or resultant differences will result. Implicit is a manual evaluation of Cobra after each change to ensure that changes were incorporated exactly by Cobra as intended.

As will be appreciated, there are several different ways or several different events that might spur a baseline change. One is taking a large planning work package that has a long duration and a considerable amount of resource and breaking it down into smaller pieces. There is another event called a re-baseline, where pre-existing work has to be significantly changed because of customer direction or program office direction.

A third change might be a correction to an inadvertent change or a change that should have been made but was not, and one has to correct it.

Note, one of the standards that part of the subject synchronization system has to uphold is that one is not changing data retroactively. One cannot change the past, in other words. One can only affect future work and future performance. Secondly, one is required to maintain funding levels year to year. These levels were recorded in the original plan and the ability to perform is limited by its program funding year to year. Thus, one cannot bring in work and one cannot push out work relative to time. One has to work within the constraints of the original plan. Lastly, one needs to meet whatever internal standards have been set for the earned value management system by the company's earned value management system Description. The System Description is a company's implementation of earned value management system in its work environment.

To summarize the baseline change process, whenever one creates an interface between two tools, one needs to define the process to manage change control. The scheduling tool, namely Microsoft Project, captures the logical sequence for performing the defined work. It holds baseline periods of performance and resources to complete the work.

The financial tool, namely Welcom Cobra, accepts the Microsoft Project data through a Cobra-defined interface and prices the work content. The Welcom Cobra system is responsible for all of the financial management for the project.

The baseline change process is designed to capture changes, planned and unplanned, that occur on every project. When program milestones change, one needs to update the schedule to the new milestones and then one needs to refresh the Welcom Cobra financial tool with the changed data. Projects are typically planned on a Planning Work Package, PWP, level, which is a summary level, after which details are added and refined when within sight, and necessary trade studies have been completed so that the work content is well understood. Finally, analysis of impacts due to these changes and current performance are evaluated using the Welcom Cobra tool so a method of program performance necessary to meet program goals can be assessed and managed.

In short, Microsoft Project captures a logical sequence for performing the fine work. Welcom Cobra then accepts the output from Microsoft Project and prices it out. The major function of Welcom Cobra is the financial management of the program based on the Microsoft Project inputs.

Most importantly, the assumption is that there is data integrity between the systems and that this data integrity is maintained. However, Microsoft Project as it presently exists is fraught with errors and stringent review is required to keep it working effectively. This is because at least eight steps are required to effectuate a change and errors can occur at each step.

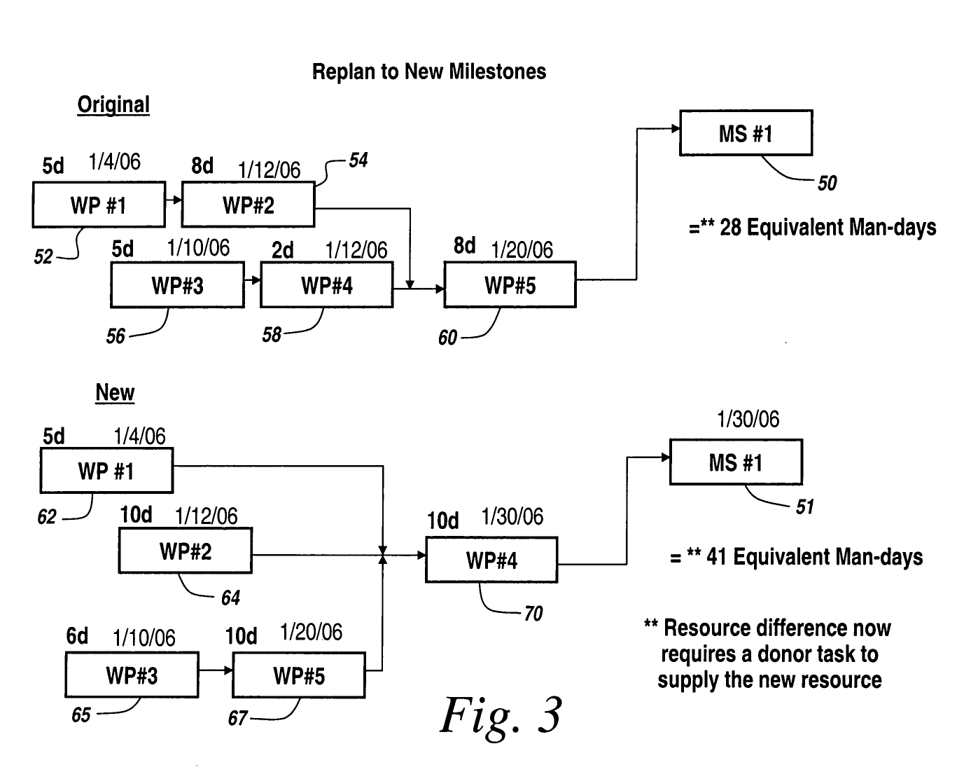

As an example of a program change and referring now to FIG. 3, this figure shows a customer-directed change where a delivery date has changed from one date to another. The change of delivery dates spurs a replan on the part of the program to redefine the work in order to meet the new delivery date. Note that the new delivery date goes from Jan. 20, 2006 to Jan. 30, 2006 as illustrated at 50 and 51. What may have happened in the background is that things may have been added, things may have been deleted, and they would be part of the change. Thus the work content that was in the original plan may have changed completely in the new plan.

As can be seen here in the original plan in terms of the work packages, WP #1, WP #2, WP #3, WI) #4 and WP #5, here illustrated at 52, 54, 56, 58 and 60, are shown to have certain interrelations. These interrelations include certain durations indicated by the small d and the number preceding the small d. Within each of these task periods of performance there are specific amounts of resources applied for performing that work.

In the new plan, one has entirely different arrangements, meaning the relationships between those works packages and the work scope of each of the work packages. As will be appreciated, the work packages are not changed in their entirety. Here it can be seen that the work product of WI) #1, 62, is combined with the work product of WP #2, here shown at 64, with the product of WI) #3, 65, the output of which is worked on at WI) #5, 67, with the output of all of these work packages being input to WP #4, here illustrated at 70. Note that within each of the task periods of performance there are specific amounts of resources applied for performing that work; and that these durations have been changed so that the equivalent man-days 28 originally planned, as illustrated at 50, being 28 are now increased to 41 equivalent man-days, as illustrated at 51. Note also that the resource difference now requires a donor task to supply the new resource.

As part of the subject invention, it has been found that the evaluation of schedule changes can more easily be performed within the scheduling tool. These changes must be communicated and incorporated by the financial management tool without breaking any of the earned value management system rules concerning retroactive changes and balancing resource adjustments for a net no-change after incorporation.

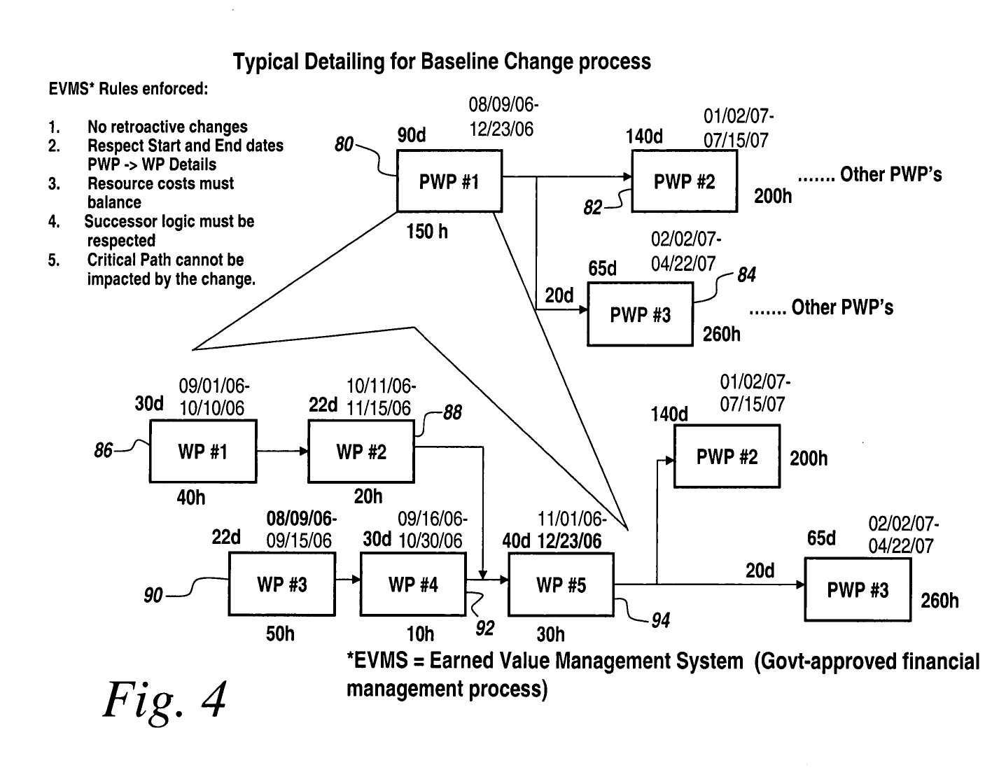

Referring now to FIG. 4, typically detailing for a baseline change process involves a detailing event where one takes a planning work package, PWP, that has a long duration and a fair amount of resources and breaks it down into smaller units. This means that there are earned value management system standards that one has to follow, which are listed in the upper left-hand corner to be (1) no retroactive changes; (2) respecting start and end dates PWP->WP Details; (3) resource cost must balance; (4) successor logic must be respected; and, (5) critical paths cannot be impacted by the change.

Thus one has to respect the date boundaries of the original planning work package when one is dealing it out. One has to respect the total resource units that are allocated to the new work packages such that they balance with what was originally provided with the planning work package. One cannot affect any prior work or any prior period changes and of course the changes have to address future work. One has to reassess impacts outside of that detailing to be sure that one is not adversely affecting any future milestones and deliveries. Note that the typical detailing is accomplished within the Microsoft Project scheduling tool, with duration times the rate being equal to the resource amount. Here one has a project work package PWP #1, shown at 80, coupled to a PWP #2, shown at 82, and to a PWP #3, shown at 84. Note that PWP #1 has 150 hours associated with it. In order to detail out PWP #1, one has a WP #1, 86, of 40 hours coupled to WP #2, 88, having an associated 20 hours, which is coupled to a PWP #3, 90, having 50 hours associated with it, which in turn is input to a WP #4, 92, with 10 hours associated with it, all of which feeds into a WP #5, 94, with 30 hours associated with it. Thus, the 150 hours is spread out across the detail from WP #1 through WP #5.

This details PWP #1 and, as can be seen, there are associated durations for each of the WP #1-WP #5 tasks. Note that above each of the WP tasks, there is a start and a stop time period, it being noted, for instance, that WP #1 stops at 10/10/06, and WP #2 starts at 10/11/06, thereby to respect start and end dates.

As noted above, the change process within Microsoft Project is error-prone. Firstly, Microsoft Project tries to maintain integrity of resource assignments by using a set of three variables, one of which is set and the other two are variable. This is described below:
Duration×Rate=Resource Units Eq. 1

When changing a duration, one needs to ensure that one sets the resource units as fixed and allow the rate to vary within changes to duration.

When changing a resource amount, one needs to set the duration as fixed and allow the rate to vary as the resource units are varied.

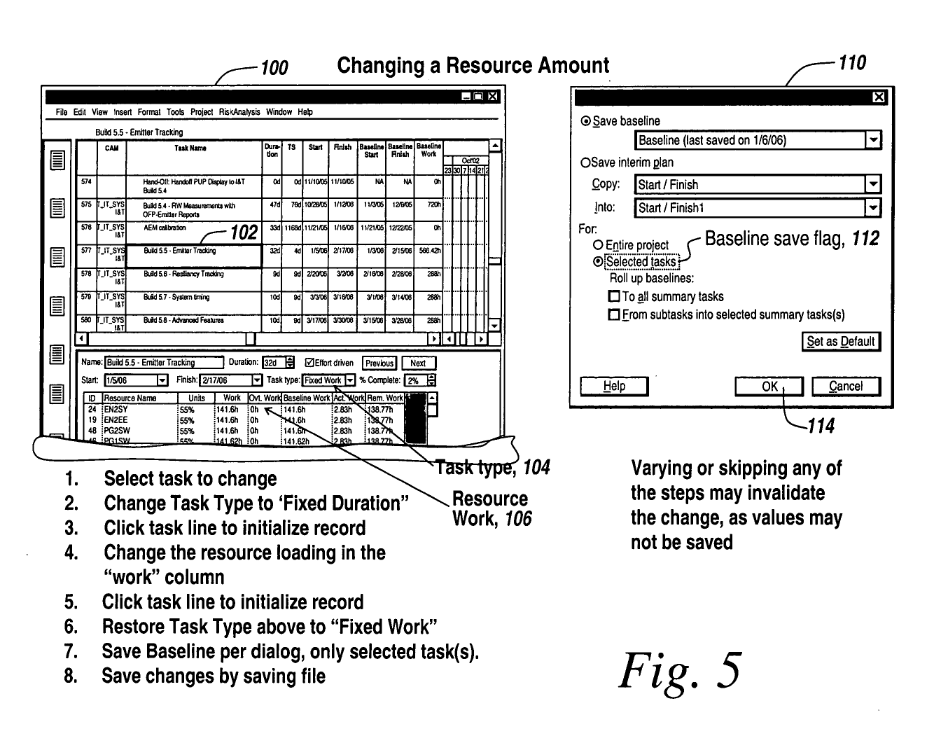

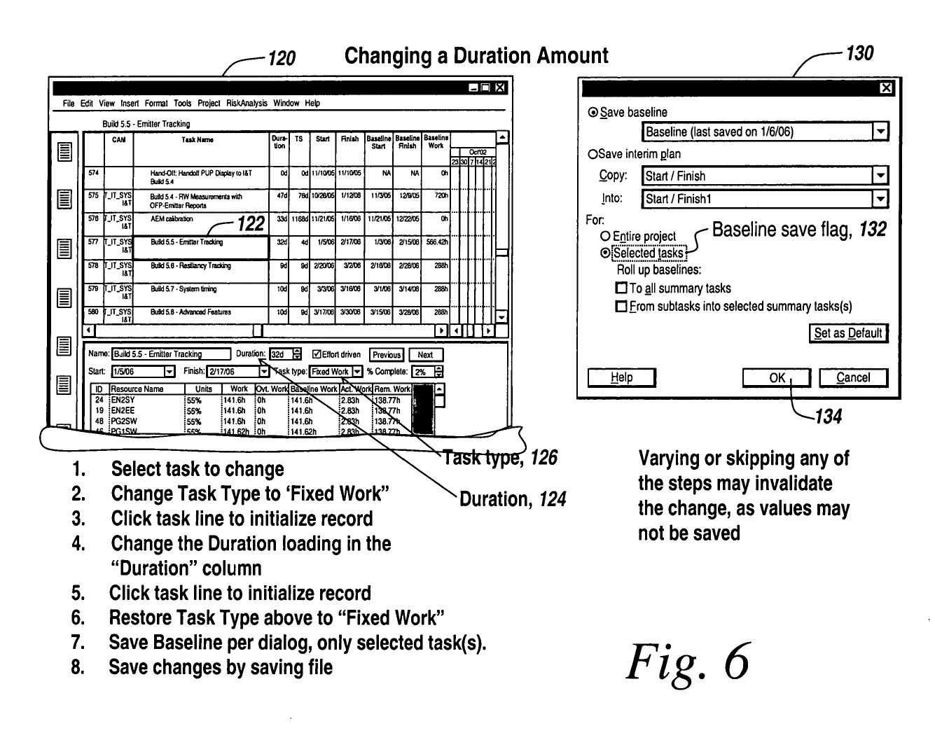

Note there are two processes for changing a program involving either a resource change or a duration change. FIGS. 5 and 6 detail two examples. The process is basically the same and one has to be aware of the state of the task type at each step. One also needs to be aware of Equation 1, such that the duration times the rate is equal to the resource units.

Within Microsoft Project, one of these parameters is held constant and the other is allowed to vary, causing a change in a third. One obviously needs to know which one is being changed and which one is to be held fixed, or one will inadvertently change the result.

In FIG. 5, one is changing a resource unit, which is the variable, so that the duration must remain fixed. By changing the resource units, the rate changes within Microsoft Project. Then one must restore the task type field to a fixed work so that the work value will be saved within Microsoft Project and will not change in the future. Here one can see in window 100 that there is a task highlighted at 102, which is a billed task that has a predetermined task type 104 and for which resource work 106 is to be changed.

As illustrated, there are eight separate steps or tasks that must be performed in Microsoft Project in order to effectuate a change. First is selecting the task to change. Second is changing the task type to a fixed duration. Third, one must select the task line to initialize the record. Then one must change the resource loading in the “work” column. Next, one must select the task line to initialize a record. This is followed by restoring the task type above to “fixed work,” followed by saving the baseline using the baseline dialogue box, here illustrated at 110. The same function is accomplished by clicking the selected task box, as illustrated by clicking the baseline save tag 112. One then saves the changes by saving the file by clicking the “OK” button, here as illustrated at 114.

Note, varying or skipping any of the eight steps may invalidate the change, as the values may not be saved. If the entire project box is inadvertently clicked, then this will eradicate all of the prior plan and work and should be assiduously avoided.

Referring now to FIG. 6, instead of changing resources, one changes the duration amount. Here, as illustrated at window 120, a task 122 is to be changed. The duration is set as illustrated at 124 and the task type is set as illustrated at 126. Again, using Microsoft Project, one has selected a task; one changes the task type to fixed work; one then selects the task line to initialize the record; and then one changes the duration loading in the duration column. One thereafter selects the task line to initialize the record, followed by restoring the task type above to “fixed work.” One then saves the change using the baseline dialogue box 130, again by clicking the baseline save tag 132, which is to exist only in the selected tasks box. Saving the file occurs by clicking OK, as illustrated at 134.

As can be seen, in the FIG. 6 example, one is doing exactly opposite to what one would do to change a resource as illustrated in FIG. 5. One has to keep the work constant by setting the fixed work flag and then change the duration field, which is another field in the window or dialogue box, and to change it to a different duration amount. One then has to ensure that one saves all of the information. Within the Microsoft Project environment, in an earned value management system environment, the work field is most important to maintain because that maintains the integrity of resource allocation, which is inputted into Welcom Cobra.

As can be seen, in Microsoft Project there are a number of tedious steps that must be performed in order to effectuate a change. This is an error-prone procedure and data integrity is at stake when transferring the changes to the financial management tool.

Not only are there inadvertent mistakes in using Microsoft Project, there are calculation issues. Calculation issues arise from the way that Microsoft Project calculates and rounds numbers versus the way that Welcom Cobra calculates and rounds numbers. Note that Microsoft Project presently calculates internally all of the numbers and, for example, the durations are units times 1000. The reason that Microsoft Project utilizes this calculation method is that it converts all of the fractional amounts to integers, and integer math within a processor is much faster than floating-point math. The result is that utilizing this calculation method helps the performance of the scheduling tool.

However, as pointed out, while the scheduling tool utilizes minutes, the Welcom Cobra financial tool utilizes decimal numbers. Note, as mentioned above, that the calculation error cannot be recovered within the project and if one has multiple differences within a cost account, which is a grouping of all of the work packages, one needs to have adjustment of both systems so that one can absorb the variance. However, while this variance can be accommodated in manual accounting procedures, calculation differences are not always accepted by Microsoft Project. Microsoft Project uses an algorithm to store significant information so it can store resource/rate information to a precision of one unit per minute. Durations are also stored in increments of one minute. Durations are calculated as follows: Minutes×10. Resources are calculated as follows:
Minutes×1000.

Unfortunately, this does not work well. This means that in the worst case, the resource can be off by 0.01 unit in the resource field. While this does not seem to be significant, it is often impossible to exactly store the resource amount found by Cobra Welcom in the Microsoft Project for many values. This difference is cumulative in a project file and may approach significant amounts on larger programs.

As noted above, with such differences between the scheduling tool and the financial management tool, the overage may have to be absorbed at the program office, which ultimately reduces profit.

What is presented in the following Appendix is a program listing for the subject system written in Borland Delphi, plus an operating and maintenance manual.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1 . In an earned value management system having a scheduling tool and a financial management tool, a method for eliminating errors between the data sets in the tools for preserving integrity, comprising the steps of:
developing a scheduling tool data set;
initially inputting the scheduling tool data set to populate the financial management tool data set;
changing the data set in the scheduling tool to reflect program changes; and,
recursively validating the two data sets to ascertain differences and to correct one data set to accurately reflect the content of the other data set.

2. The method of claim 1, wherein the data set in the scheduling tool is corrected to reflect the data set in the financial management tool.

3. The method of claim 1, wherein the recursive validating step includes the step of comparing data in the two sets, flagging differences in the data sets, ascertaining the severity of the flagged differences and changing only the associated data when the severity is significant.

4. The method of claim 3, wherein the significance of the flagged difference is determined by a human being.

5. The method of claim 4, wherein a data set is changed in the scheduling tool only after human intervention.

6. The method of claim 3, wherein the significance of the flagged difference is determined automatically.

7. The method of claim 3, wherein the associated data is updated automatically.

8. The method of claim 7, wherein the automatic data update step is preceded by an interrupt in the automatic process to permit evaluation of flagged difference severity.

9. The method of claim 3, wherein the data comparing step is done automatically.

10. The method of claim 9, and further including the steps of displaying flagged differences for human evaluation.

11. The method of claim 10, wherein the data is presented as line items and wherein those lines having flagged differences are highlighted.

12. The method of claim 11, and further including the step of providing a dialogue box adjacent a line item and wherein evaluated line items for which a data set is to be changed is selectable by a mark in a corresponding dialogue box.

13. The method of claim 3, wherein changes for associated data are made in the scheduling tool.

14. The method of claim 3, wherein changes for associated data are made in the financial management tool.

15. The method of claim 3, wherein changes to a data set are made manually after evaluation of severity.

16. The method of claim 2, wherein after a change to correct data differences in the scheduling tool, the resultant scheduling tool data set is re-compared with the new data set in the financial management tool and differences flagged, whereby any further data set differences can be evaluated and corrected.

17. In an earned value management system having a scheduling tool and a financial management tool, a system for eliminating errors between the data sets in the tools for preserving integrity, comprising:
a scheduling tool data set;
an interface for coupling said scheduling tool data set to populate the data set for said financial management tool;
an input device for changing the data set in said scheduling tool reflecting program changes; and,
a module for recursively validating the two data sets created as a result of said change to ascertain differences and for converting one data set to accurately reflect the other data set.

18. The system of claim 17, wherein said module for recursively validating the two data sets includes a comparator for comparing the data in the two sets, for flagging differences in the two data sets and, upon ascertaining the severity of the flagged differences, changing only data in an associated data set when the severity of the flagged differences is significant.

19. The system of claim 18, wherein said module includes an automatic update process for changing the data in said associated data set.

20. The system of claim 18, wherein said module includes a display of line items in said data sets and means for highlighting those line items between said data sets that are different, whereby the highlighted differences can be evaluated for severity.
